(19) United States
(12) Patent Application Publication
(10) Pub. No.: US 2025/0117751 A1
(43) Pub. Date: Apr. 10, 2025

(54) MACHINE LEARNING-BASED METHODS FOR MATCHING SKILLS TO ROLES AND COURSES

(71) Applicant: Retrain.ai Inc., New York, NY (US)

(72) Inventors: Shay DAVID, Tel Aviv (IL); Isabelle BICHLER, Cresskill, NJ (US); Avi SIMON, Tel Aviv (IL); Zach SOLAN, Tel Aviv (IL)

(73) Assignee: Retrain.ai Inc., New York, NY (US)

(21) Appl. No.: 18/480,989

(22) Filed: Oct. 4, 2023

(51) Int. Cl. G06Q 10/1053; G06F 16/903

(52) U.S. Cl. CPC G06Q 10/1053; G06F 16/90335

(57) ABSTRACT

Techniques for extracting skills from unstructured raw data are provided. The method includes determining at least one normalized role that match a role of the raw data, wherein the match is determined based on a first semantic similarity score generated for each of normalized roles of a set of normalized roles; generating a subset of normalized tasks that are associated with the at least one normalized role; determining, based on a second semantic similarity score, at least one normalized task for a task data unit of the raw data, wherein the task data unit is a portion of the raw data that describes tasks of the role, wherein the at least one normalized task is a normalized task in the subset of normalized tasks; aggregating skills that are associated with the at least one normalized task; and generating structured skill data of the raw data using the aggregated skills.

### TECHNICAL FIELD

The present disclosure relates generally to natural language processing, more specifically to semantic extraction of skills using machine learning technologies.

### BACKGROUND

Technology behind human resources is known for its data rich, information poor (DRIP) state due to abundance of data ranging from individual candidates, roles, companies, as well as related experiences, qualifications, and more. Such continuous collection of data has gained further momentum with the advancement of interconnected computer networks and smart devices. However, utilization and discovery of relevant information from such abundant data lag far behind the rate of data collection, which results in loss of valuable information.

Uncovering information from the collected data can be particularly beneficial in the area of talent acquisition in order to hire competent candidates for positions. The process of hiring a candidate consumes many company resources including employee times, company budget, and the like, which can not only add up, but can multiply when unfit candidates are hired. To this end, techniques to effectively uncover candidate information (e.g., skills, qualification, ability, knowledge, etc.) and reduce financial impact for companies and candidates are desired.

Currently implemented approach for discovering information include keyword search or named entity recognition (NER), deep learning pattern recognition based on artificial intelligence, and more. The keyword search approach relies on exact entities that are included in the predetermined dictionaries and thus, low in accuracy. Deep learning pattern recognition has displayed some improvement in identifying potential candidates for specific roles. However, it has been identified that such black-box approach using artificial intelligence has created unintentional and undesirable bias toward certain demographics (e.g., sex, race, etc.). Although current approaches provide improvements from manual labeling and selection to reduce consumption of resources, solutions for efficient discovery of information and unbiased matching in the area talent acquisition still remain to be seen.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Some embodiments herein relate to a method. For example, method may include determining at least one normalized role that matches a role of the raw data, where the match is determined based on a first semantic similarity score generated for each of normalized roles of a set of normalized roles. Method may also include generating a subset of normalized tasks that are associated with the at least one normalized role. Method may furthermore include determining, based on a second semantic similarity score, at least one normalized task for a task data unit of the raw data, where the task data unit is a portion of the raw data that describes tasks of the role, where the at least one normalized task for the task data unit is a normalized task in the subset of normalized tasks. Method may in addition include aggregating skills that are associated with the at least one normalized task. Method may moreover include generating structured skill data of the raw data using the aggregated skills. Other embodiments of this aspect include corresponding computer systems, apparatus, and computer programs recorded on one or more computer storage devices, each configured to perform the actions of the methods.

Some embodiments herein relate to non-transitory computer readable medium that may include determining at least one normalized role that match a role of the raw data, where the match is determined based on a first semantic similarity score generated for each of normalized roles of a set of normalized roles; generating a subset of normalized tasks that are associated with the at least one normalized role; determining, based on a second semantic similarity score, at least one normalized task for a task data unit of the raw data, where the task data unit is a portion of the raw data that describes tasks of the role, where the at least one normalized task for the task data unit is a normalized task in the subset of normalized tasks; aggregating skills that are associated with the at least one normalized task; and generating structured skill data of the raw data using the aggregated skills. Other embodiments of this aspect include corresponding computer systems, apparatus, and computer programs recorded on one or more computer storage devices, each configured to perform the actions of the methods.

Some embodiments herein relate to a system that may include one or more processors. System may also include a memory, the memory containing instructions that, when executed by the one or more processors, configure the system to: determine at least one normalized role that match a role of the raw data, where the match is determined based on a first semantic similarity score generated for each of normalized roles of a set of normalized roles. System may in addition include generating a subset of normalized tasks that are associated with the at least one normalized role. System may moreover include determine, based on a second semantic similarity score, at least one normalized task for a task data unit of the raw data, where the task data unit is a portion of the raw data that describes tasks of the role, where the at least one normalized task for the task data unit is a normalized task in the subset of normalized tasks. System may also include aggregate skills that are associated with the at least one normalized task. System may furthermore include generating structured skill data of the raw data using the aggregated skills. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for determining optimal matches according to an embodiment.

FIG. 3 is a flowchart illustrating a method for extracting skills according to an embodiment.

FIG. 4 is a schematic diagram illustrating extraction of skills from unstructured data in an example embodiment.

FIG. 5 is a schematic diagram of a skill generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include methods and systems for semantic extraction of skills to generate structured skill data for explainable matching. A multi-stage artificial intelligence (AI)-based semantic technique is utilized to progressively extract skills from unstructured data presenting freely written text of raw data (e.g., job description, curriculum vitae, course descriptions, and more) with improved accuracy and efficiency. The semantic technique clusters segmented data units and portions thereof based on semantic proximity (i.e., similar meaning and/or content) in order to identify such clusters as normalized roles and normalized tasks. The disclosed embodiments utilize semantic similarity scores that define semantic proximity to focus on select number of normalized roles, and further to a subset of normalized tasks related to the select normalized roles. In furtherance, the subset of normalized tasks is semantically clustered and analyzed to determine normalized tasks and associated skills for the unstructured data. The disclosed embodiments further generate structured skill data including the semantically extracted skills with improved accuracy and computer efficiency. Moreover, such structured skill data may be effectively retrieved and compared to discovering matching raw data for input raw data (e.g., textual data, documents, etc.).

It has been identified that currently implemented methods of discovering information from raw data are resource intensive in terms of computer processing and storage. The disclosed embodiments, however, provide a semantic extraction technique that enables accurate and efficient extraction of skills from unstructured raw data. The multi-stage semantic technique extracts relevant skills using normalized roles and tasks to generate concise structured skill data for storage, retrieval, and processing. It should be noted that the identification of segmented unstructured data as normalized roles and/or normalized tasks controls the amount and size of the data, and further systematically reduces the data for processing, thereby conserving computing resources.

In addition, the disclosed embodiments generate semantic similarity scores for the normalized roles and tasks to objectively identify and extract skills from the unstructured data. Identifying roles, tasks, and/or skills by a person may often be subjective, based on their feelings and presumptions at the time of decision and further based on personal knowledge and familiarity of the role, tasks, and skills. For example, a human resource personnel may identify one task from the paragraph of a job description based on their feeling or knowledge over another task that is described in the same paragraph. The embodiments disclosed determine a semantic similarity score between the normalized task and the unstructured data (e.g., paragraph of free text) in order to objectively and accurately determine the normalized tasks and the respectively related skills. Moreover, it should be noted that the database of normalized roles and normalized tasks includes more than tens of thousands of normalized roles and tasks and may continuously change with the job market. To this end, just considering the vast volume of data of normalized roles and tasks, manual comparison and determination of semantic similarity scores cannot be performed for such objective extraction of skills.

The disclosed embodiments further provide techniques for efficient retrieval and matching of raw data by utilizing the structured skill data for each of the raw data. The structured skill data that includes a skill vector of the extracted skills are used to locate and retrieve relevant raw data based on the extracted skill. It should be noted that the structured skill data not only allows retrieval of relevant raw data, but also at fast speed without repeated analysis of the raw data and by focusing on the skill data. Moreover, the matching of raw data by the structured skill data allows objective skill-based comparison of the raw data without bias from other non-skill related data such as, personal information (e.g., gender, ethnicity, sexual orientation, disability, etc.), authors, sources, and the like, and any combination thereof. To this end, the disclosed embodiments provide techniques that further improve computer performances related to processing speed and power by skill-based matching using skill vectors of the structured skill data.

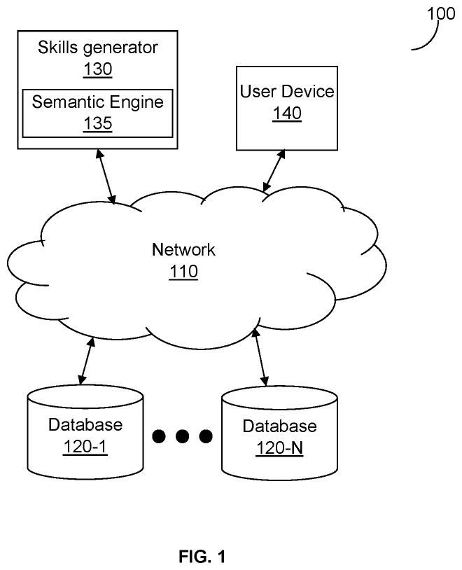

FIG. 1 shows an example network diagram 100 utilized to describe the various disclosed embodiments. In the example network diagram 100, a plurality of databases 120-1 through 120-N (hereinafter referred to individually as a database 120 and collectively as databases 120, merely for simplicity purposes), a skills generator 130, and a user device 140 are communicatively connected via a network 110. The network 110 may be, but is not limited to, a wireless, a cellular or wired network, a local area network (LAN), a wide area network (WAN), a metro area network (MAN), the Internet, the worldwide web (WWW), similar networks, and any combination thereof.

A database 120 stores raw data that are related to candidates and/or roles of jobs, for example, but not limited to, curriculum vitae (CV) of candidates, candidate profiles, job descriptions, job postings, and the like. The raw data may be collected from external sources such as, but not limited to, company websites, Job boards, social media, and the like, and any combination thereof. Such raw data includes unstructured data in the natural language which may be in various forms such as, but not limited to, text, video, audio, image, and the like, and more. The unstructured data may be stored as textual data to include various professional experiences and information, and the like, and any combination thereof. The raw data further includes personal information (e.g., job title, name, address, etc.), metadata (e.g., author, time stamp, source, document type, etc.), and the like, and any combination thereof.

The database 120 may include a talent database including a plurality of normalized roles, tasks, skills, and the like, in the field of talent acquisition. The talent database may include a large list of normalized roles that are job titles, for example, but not limited to, sales manager, technical lead, quality control engineer, and the like, and more that exists in the current job market. In addition, the talent database may include a large number of normalized tasks (or activities) that are each associated with at least one normalized role from the list of normalized roles in the database 120. The normalized tasks are standardized action items that are performed in the associated role. As an example, the normalized tasks for a product leader (i.e., the role) may include at least one of: direct team activities, establish task priorities, identify and communicate technical problems and solutions, and the like.

In an embodiment, the talent database further includes a plurality of skills in relation to one or more normalized tasks of the database 120. The skills define an ability, knowledge, capability, and the like, desired or needed to successfully complete the related normalized task. In an embodiment, an artificial intelligence (AI)-based algorithm such as a machine learning algorithm, a deep learning algorithm, and the like, may be applied to data from external sources to update the talent database to reflect current field of talent acquisition and job market. In an example embodiment, the talent database may include a substantially large number of normalized data including 50,000 roles, 100,000 tasks, and 50,000 skills. It should be noted that the normalized roles, tasks, and skills are stored in the talent database in association with one another. In an embodiment, the normalized data may be represented in an interconnected network that portrays the relationship between the roles, tasks, and skills in the database 120.

According to the disclosed embodiment, the database 120 may be a skills database that is built by storing structured skill data that are generated for each of the collected (or stored) raw data. Such structured skill data include at least one skill extracted from unstructured data describing the candidate and/or role. The method for extracting at least one skill from the raw data is executed in the skills generator 130 and further described herein below. In addition, the structured skill data may include scores such as, but not limited to, proficiency score, importance score, and the like, that further define each skill with respect to mapped tasks. It should be noted that the generated structured data allows rapid retrieval of raw data based on skills that are relevant in human resource technology and talent acquisition, thereby increasing processing efficiency and conserving computing resources.

The skills generator 130 is configured to process the raw data received from the databases 120 and/or external sources to extract at least one skill. The extraction of the at least one skill is performed in multiple stages that are scalable and explainable. The skill generator 130 may be configured with a semantic engine 135 that includes at least one model such as language model, an advanced language model, and the like, that is applied to the unstructured data in the raw data for processing. The unstructured data that may be textual data in the natural language are segmented into data units prior to semantic analysis by the semantic engine 135.

The semantic engine 135 performs semantic analysis of the data units to understand the meaning and content of the data units and cluster them by their similarity. Such semantic clusters are identified as normalized roles and/or tasks during the multi-stage extraction process. The normalized roles and normalized tasks are identified from a predetermined set stored in the talent database 120. A progressive semantic approach is performed on the unstructured data to first identify the normalized roles, then to identify the normalized tasks of the unstructured data that are associated with the identified normalized roles. That is, other normalized tasks irrelevant to the identified normalized roles are not retrieved or processed in the second stage of the progressive semantic extraction. It should be noted that such a progressive approach allows improved accuracy and computer efficiency, for memory and processing, in the extraction of skills from the unstructured data.

The skills generator 130 is configured to map each of the determined normalized tasks to one or more skills selected from a predetermined list of skills associated to the normalized task of the normalized role. In an embodiment, structured data may be generated for each raw data including, for example, but not limited to, one or more skills, scores for each skill, and the like, and any combination thereof. It should be noted that a skill may have more than one score (e.g., proficiency score) with respect to the associated role. As an example, a management software skill extracted from a job description may have desired proficiency scores of 0.7 for a financial management role and 0.3 for an entry levels sales associate based on the need. It should be noted that the extraction and storage of skills from raw data enables objective analysis of the raw data based on skills that are critical information in talent acquisitions and hiring. In an embodiment, the extracted skills may be represented as a skill vector of the structured skill data. In a further embodiment, an aggregated value indicating the skill and respective score for each skill may be included in the skill vector the raw data.

The skills generator 130 is further configured to determine a match between raw data, which may be retrieved from the databases 120, external resources, user devices 140, and more. Any new data may be processed to extract skills and to generate the structured skill data, which are utilized for objective determination of a matching data (i.e., candidate matching skills). In an embodiment, a match probability is determined for each pair of raw data to determine an optimal match. In an embodiment, the match probability may be generated by determining the distance between the skill vectors of the raw data. The objective and visible matching of extracted skills in the raw data enables a transparent process of matching that is fully explainable. It should be further noted that the multi-stage processing of the raw data provides granularity in data for improved accuracy and efficiency in the hiring process to conserve computational and company resources.

The user device 140 may be, but is not limited to, a personal computer, a laptop, a tablet computer, a smartphone, a wearable computing device, or any other device capable of receiving and displaying notifications. The user device 140 is configured to receive outputs from the skills generator 130 including, but not limited to, extracted task data, mapped skills data, overall match with an input data, and the like, and any combination thereof. In an embodiment, the user device 140 may access such data and outputs through application programming interfaces (APIs).

The user device 140 is configured with an interactive graphical user interface (GUI) that displays such outputs as well as additional information such as, but not limited to, summary of CV, current status, and the like, that are determined based on the outputs. One or more input interfaces of the user device 140 may be utilized to receive input from a user providing description of oneself through free form texts, and the like, and more. Such input data may be utilized at the skills generator 130 to generate outputs as described herein below. The user of the user device 140 may be, for example, but not limited to, a human resource personnel or recruiter seeking for potential candidates for a role, a potential candidate seeking a role in various companies, an employee looking for opportunities in a new role, and the like, and more.

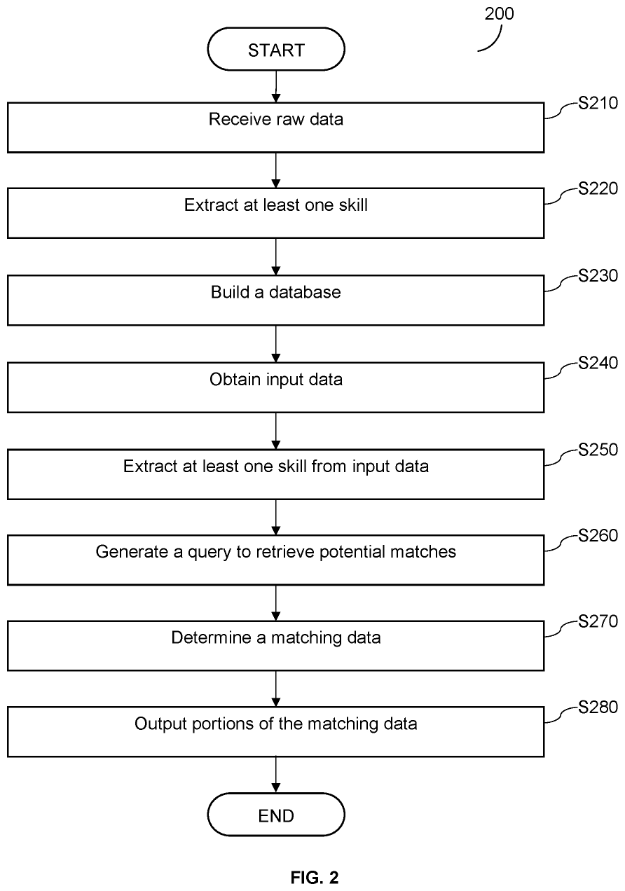

FIG. 2 shows an example flowchart illustrating a method for determining optimal matches according to an embodiment. The method described herein may be executed by the skills generator 130.

At S210, raw data is received. The raw data are related to candidates and/or roles of jobs, for example, CV of candidates, candidate profiles on social media, candidate profiles on websites, job descriptions, job postings, course descriptions, and the like, and more. In an embodiment, the unstructured data of the raw data may be natural language text. In a further embodiment, the raw data may be collected from external sources such as, but not limited to, global job boards, global companies, local job boards, peer group job boards, and the like as well as internal sources such as, but not limited to, company database, and more. As an example, raw data received of a job description includes one or more paragraphs outlining the responsibilities of this role as well as multiple bullet points presenting preferred qualifications for the role.

At S220, at least one skill is extracted for each raw data received. A skill is an ability, knowledge, or capability that is represented in the raw data. As an example, in a CV of a candidate, the each skill represents an ability, knowledge, a capability, or the like, that the candidate presents to have performed, possess, and the like, and any combination thereof. In another example for a job description raw data, the skills may be ability, knowledge, or the like, that is desired in a person at the specific role of the job description. In yet another example, in a course description, skills may include, for example, prerequisite experiences, knowledge that may be gained through this course, and the like, and any combination thereof.

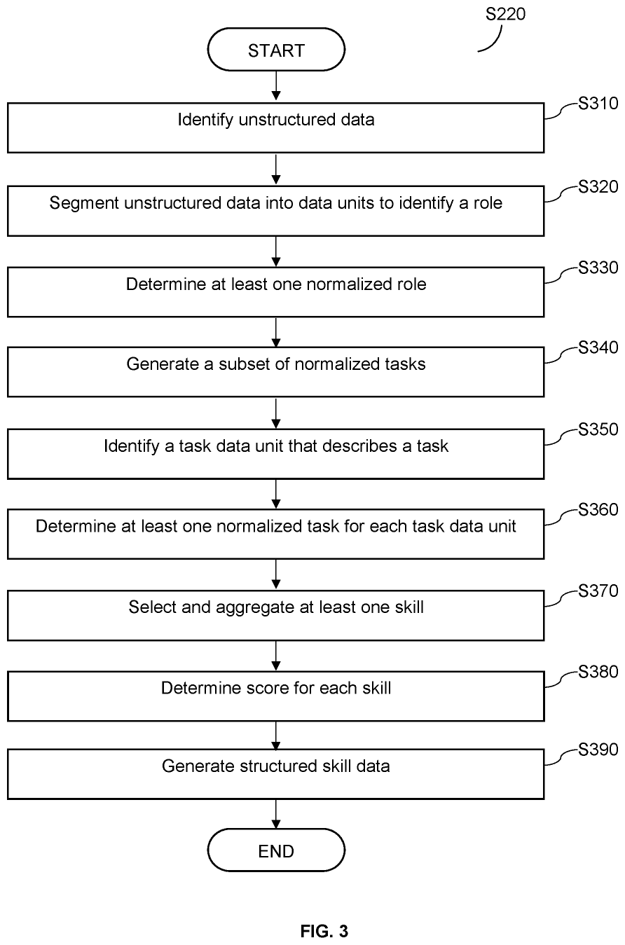

In an embodiment, at least one algorithm, such as a machine learning algorithm, a neural network, deep learning, or the like, is applied to identify and extract the at least one skill from the unstructured raw data. In an embodiment, a predefined list of skills, each associated with one or more normalized tasks, is utilized to identify the extracted at least one skill as a specific skill. That is, the extracted skill is a specific skill selected from the predefined list of skills stored in a database (e.g., the database 120, FIG. 1). In an embodiment, the extracted skills are represented and stored as skill vectors. The skills vectors include a value for each of the skills in the list of skills to represent the skills that are presented and not presented in the raw data. The value for each skill is weighted based on the scores of proficiency and/or importance with respect to the associated role and/or task. In a further embodiment, the skills in the predefined list of skills are each assigned with a unique identification (ID). The process of extracting the at least one skill is described in further detail herein below in FIG. 3. In an embodiment, the extracted at least one skill is utilized to generate structured skill data for the raw data. The structured skill data includes the at least one extracted skill from the raw data as well as scores of proficiency and/or importance for each of the skills.

At S230, a database is built. The database is a skills database that stores the raw data, metadata of the raw data (e.g., time stamp, source, authors, keywords, document type, etc.), structured skill data, and more that may be queried for further analysis.

At S240, an input data is obtained. The input data includes job-related information, similar to that of the raw data, and obtained to identify a matching data. Such input data may be received from, for example, but not limited to, a user device (e.g., the user device 140, FIG. 1), an internal database, external sources (e.g., job boards, job websites, etc.) and the like, as raw data. As noted above, raw data are in the natural language that may be, for example, but not limited to, CV of candidates, candidate profiles on social media, candidate profiles on websites, job descriptions, job postings, course descriptions, and the like, and more. In another embodiment, the input data may include structured skill data that are obtained from the database (e.g., the database 120, FIG. 1).

At S250, at least one skill is extracted from the input data. The skill represents an ability, knowledge, capability, or the like, that is presented in the input data. The extraction of the at least one skill is performed as described above in S220 and in further detail in FIG. 3 below. In some embodiments, the operation to extract the at least one skill may be omitted for certain input data when associated structured skills data is stored and may be retrieved from the database (e.g., the database 120, FIG. 1). In such a case, the respective structured skills data may be ingested from the database. As an example, the input data may be a CV of a candidate for which the extraction of skills have been previously performed. In such a case, the raw data, metadata, and the structured skill data is retrieved from the stored database.

At S260, a query is generated to retrieve potential matches from the database. The query relates to the skills extracted from the input data in order to discover potential matches including relevant skills to the input data. In an embodiment, the query is generated to define parameters such as, but not limited to, document type, job title, category of skills, specific skills, scores associated with skills, and the like, and any combination thereof. In a further embodiment, one or more extracted skills of the input data are included in the query to retrieve potential matches with corresponding skills. The document type defines the document of the raw data, for example, but not limited to, job description, CV of candidate, candidate profile, and the like. In an example embodiment, the query may define a specific document type that is different from the document type of the input data. In another example embodiment, the extracted skills to be defined in the query may be selected based on scores of the skills, for example, proficiency, importance, and the like. It should be noted that the retrieval of potential matches using the structured skill data is not only more relevant, but also allows rapid retrieval of such matches. The structured skill data eliminates repeated processing of unstructured raw data and further reduces processing by discovering matches using relevant skill information, thereby conserving computing resources.

In an embodiment, the retrieved potential matches may each include, for example, but not limited to, raw data, structured skill data, and the like, and any combination thereof. As an example, a CV of candidate seeking financial manager position is received as input data and the structured skill data including extracted skills and scores for each extracted skill, represented as a skill vector, are determined. In the same example, a query is generated to fetch job descriptions with financial manager titles (or roles), and skills (e.g., project management software and instructing). The results are ranked based on the scores in the range of the CV input data. The score is determined based on, for example, the Euclidean distance between vectors representing job description on the CV input date. In an embodiment, the retrieved potential matches may be stored in a memory and/or a database (e.g., the database 120, FIG. 1) in association to the input data. It should be noted that potential matches that include similar skills to the input data are discovered with improved accuracy and reduced processing time by utilizing the generated query.

At S270, a matching data is determined for the input data. The matching data is one of the potential matches with a match probability above a predetermined threshold value. At least one algorithm is applied to the structured skill data of the potential matches and the structured skill data of the input data to determine the match probability for each of the retrieved potential matches. In an embodiment, the at least one algorithm is applied to the skill vectors generated for the input data and the potential matches to determine a distance, for example, but not limited to, a Euclidean distance, Cosine similarity, Jaccard similarity, and the like, and more between the skill vector from the input data and the skill vector of a potential match. In an example embodiment, short distance between the skill vectors of the input data and a first potential match indicates a good match between the input data and the first potential match to result in a high match probability. In an embodiment, a pre-processing step is performed such vectors using, for example, a dimension reduction algorithm.

The match probability may be determined based on, for example, but not limited to, skills in the structured skill data, importance score of each skill, proficiency score of each skill, and the like, and any combination thereof. That is, a high match probability not only indicates that the potential match and input data share common skills, but also that the respective scores for such skills are within a predetermined range. As an example, a first potential match (e.g., a first job description) includes necessary skills of “attention to details” and “interpret technical text” with proficiency scores of 0.8 and 0.3, respectively; and a second potential match (e.g., a second job description) includes identical skills of “attention to details” and “interpret technical text” with desired proficiency scores of 0.4 and 0.8, respectively. In such a scenario where the input data includes the same skills with proficiency scores of 0.5 and 0.9, respectively, the second potential match will have a higher match probability than the first potential match based on the closeness of the proficiency scores to that of the input data. In a further embodiment, the category of skills such as, but not limited to, service, tools, and the like, which is defined by the characteristics of the skill, may be utilized for determining the matching data. For example, skills in the tools category may be given greater weight and priority to determine a match than skills in the character category.

In an embodiment, the retrieved potential matches may be ranked from highest to lowest match probabilities. In an example embodiment, the match probability may be a number between 0 and 1 and provided as a percentage. It should be noted that the determination of the matching data using skills improves accuracy as well as processing speed by utilizing relevant and informative parameters, such as skills (e.g., specific skills, category of skills, etc.), proficiencies, and the like. To this end, the amount of data processing is significantly reduced to identify the matching data that satisfies and corresponds to the desired qualifications of the input data. In an embodiment, the match probability of each potential match and the input data may be stored at a database (e.g., the database 120, FIG. 1).

At S280, portions of the matching data are output. Portions of the matching data may include, for example, excerpts from the raw data, excerpts from the unstructured data, one or more skills and/or respective scores in the structured skill data, determined matching probability, and the like and more. In an embodiment, a language model, a large language model, or the like, may be applied to output in the natural language. In an embodiment, the matching data may be further processed and caused to be displayed via a user device (e.g., the user device 140, FIG. 1). In a further embodiment, an interactive graphical user interface (GUI) may be utilized to display portions of the matching data via the user device.

According to the disclosed embodiments, the matching data for the input data is determined based on structured skill data. The skill data that are extracted from the raw data (e.g., text, audio, etc. in natural language) allows objective, unbiased mapping of potential matches to the input data. That is, matching is performed based on skills rather than other elements such as, but not limited to, gender, ethnicity, geographical location, and the like, and any combination thereof. A plurality of rules defined by weights, scores, rankings, and the like are applied to the skill data to determine the matching probability that may otherwise include subjective decisions. The structured skill data enables retrieving potential matches that include skills that are relevant, if not identical, to the input data. To this end, relevant data are rapidly retrieved from the database to reduce the amount of processing, thereby conserving computing resources even further.

It should be noted that the description with respect to skills and roles is presented for illustrative purposes and does not limit the scope of the various disclosed embodiments described herein. One of ordinary skills in the art would understand that other parameters or traits may be extracted from raw data and utilized for improved objective matching between raw data.

FIG. 3 shows an example flowchart S220 illustrating a method for extracting skills from raw data to generate structured skill data according to an embodiment. The method described herein provides details of the steps S220 and S250 disclosed in FIG. 2 above and may be executed by the skills generator 130. In an embodiment, the skill generator 130 may include a semantic engine 135 that identifies meanings of at least portions of the raw data represented in the natural language.

At S310, unstructured data are identified from the raw data. The raw data is related to candidates and/or roles of jobs and includes unstructured data that may be, for example, freely written text, and the like. In an embodiment, the unstructured data may be portions of, for example, CV of candidates, candidate profiles on social media, candidate profiles on websites, job descriptions, job postings, course descriptions, and the like, and more. In an embodiment, the unstructured data may be represented as textual data. As an example, raw data of a resume includes unstructured data describing the candidate's experiences at different roles in paragraphs and/or bullet points. In another example, the raw data is a course description presenting various knowledge and skills one could gain through taking the respective course in multiple paragraphs.

At S320, the unstructured data are segmented into data units to identify data units that represent a role. The unstructured data that includes freely written text is segmented into shorter data units using a parsing mechanism. The data units may be portions of the unstructured textual data such as, but not limited to, a paragraph, bullet point, sentences, clauses, and the like. In an embodiment, segmented data units that describe a role are identified.

At S330, at least one normalized role that matches the role described role is determined. At least one algorithm such as, but not limited to, latent semantic analysis (LSA), or the like, may be applied to the parsed data units of the unstructured data to determine a semantic similarity score for the role described in the data unit with respect to each of the normalized roles. In an embodiment, a semantic engine (e.g., the semantic engine 135, FIG. 1) is utilized to generate the semantic similarity score that indicates similarity in meaning and content of the parsed data units and the normalized roles. Such analysis allows clustering of data units based on semantic proximity to identify the multiple parsed data units in the semantic cluster as a single normalized role, thereby reducing the number of roles to be stored and processed. In an embodiment, a set of normalized roles are predetermined and stored in a talent database (e.g., the database 120, FIG. 1). In an example embodiment, the set of normalized roles may include about 50,000 normalized roles. In a further example embodiment, a subset of normalized roles may be determined from the larger set based on the identified role to determine semantic similarity scores for the subset of normalized roles. Using a subset of normalized roles allows faster processing and matching.

In an embodiment, the normalized roles are ranked from high to low semantic similarity score in order to select a predetermined number of top scored normalized roles as the at least one normalized role that matches the identified role. The top scored normalized roles are normalized roles that best match the identified role in account of the content of the parsed unstructured data that describe the identified role.

At S340, a subset of normalized tasks is generated based on the at least one normalized role determined from the unstructured data. The subset includes normalized tasks associated with each of the at least one not normalized role as stored in the task database (e.g., the database 120, FIG. 1). In an embodiment, the task database includes a large list of normalized tasks that are associated with one or more normalized roles stored therewith. In an example embodiment, the database may include about 100,000 normalized tasks. It should be noted that the generated subset narrows down the number of normalized tasks to be further stored and processed.

At S350, task data units are identified from the unstructured data. The task data unit is a parsed portion of the unstructured data such as, but not limited to, paragraph, bullet points, sentences, clauses, and the like, and more that describes a task of the role in the natural language.

At S360, at least one normalized task is determined for each task data unit. The at least one normalized task is identified from the subset of normalized tasks generated in S340. At least one algorithm such as a semantic analysis is applied, via the semantic engine (e.g., the semantic engine 135, FIG. 1), to each task data unit. In an embodiment, the semantic analysis enables clustering of tasks with similar content (or meaning) as a single normalized task. In addition, a semantic similarity score that represents a semantic similarity between the normalized task and the task data unit is generated. In an embodiment, for each task data unit, the normalized tasks ranks are ranked from high to low semantic similarity score. In a further embodiment, the normalized tasks with a respective semantic similarity score that is greater than a predetermined value may be selected as the normalized task for the task data unit. In another embodiment, a predetermined number of top ranked normalized tasks may be selected as the normalized task for the task data unit. In an embodiment, the at least one normalized task determined for each task data unit may be stored in a memory or a database (e.g., the database 120, FIG. 1) in association with the unstructured data. It should be noted that, in addition to processing a subset of normalized tasks, the semantic analysis approach enables clustering of similar tasks in the task data units to the normalized tasks to further conserve computing resources in memory and processing power.

At S370, at least one skill is selected based on the normalized tasks and aggregated. The skill is, for example, an ability, knowledge, capability, or the like, and any combination thereof, that is identified as a necessity to perform the respective task. The skills that are associated with the determined normalized tasks are retrieved from a task database (e.g., the database 120, FIG. 1). In an example embodiment, the database includes about 50,000 skills that may each belong to one or more normalized tasks. In a further example embodiment, each skill may be configured with a unique ID. In an embodiment, the skills associated with each of the normalized tasks determined for the task data units may be retrieved and aggregated. In an embodiment, a skill vector that includes the aggregated skills may be generated for the raw data.

In some embodiments, a classification model, such as hierarchical classification, may be applied to the identified skills to classify the skills into type (or categories) and sub-types (or sub-categories). In an example embodiment, the skill may be classified into categories such as, but not limited to, service, tools, and the like, depending on the characteristics of the skill. As an example, skills in the “service” category may include actively listening, responsive, and the like; and skills in the “tools” may include managing software, use technical documentation, and the like.

At S380, a score is determined for each of the at least one skill. The score is determined from the unstructured data of the raw data and provides additional details for each of the at least one skill in relation to the normalized task and/or normalized role. In an embodiment, the score is, for example, a proficiency score, an importance score, and the like, of the skill in account of the role of the raw data. The proficiency score is a proficiency level of the skill to perform the task in the content of the role. Depending on the type of document, the proficiency level of the skill may be, for example, the level of proficiency desired, the level of proficiency one possesses, the level of proficiency one can gain, and the like, and any combination thereof. As an example, the proficiency score for a skill in a CV is the proficiency level as presented in the CV (i.e., proficiency level of the candidate) and the proficiency score for a skill in a job description is a desired proficiency level for a person at the role of the job description.

In an embodiment, the importance score defines value or helpfulness of the skill to perform the task in the context of the role. In an example embodiment, the proficiency score may an integer from 1 to 5, indicating “novice” to “expert.” In a further embodiment, the importance score may be an integer from 1 to 5, indicating “not important” to “extremely important.” A skill with a high importance score (i.e., extremely important) is a skill that is critically required to perform the respective task in the context of the role. In an embodiment, the skill vector that includes the aggregated skills may be updated to reflect the scores determined for each of the at least one skill. The value for each skill may be weighted based on the determined scores to update the skill vector that includes the extracted skills.

In an example embodiment, the proficiency level may be determined based on, for example, number of hours, education, and the like, in the CV of the candidate using an equation as shown below:

$${Skill}_{k} = {( Sum ( Hours )}_{i} ) = Days ( {D}_{i 2} - {D}_{i 1} ) * 8 * Education\_weight \qquad ( 1 )$$

The example equation 1 above calculates the number of hours, Sum (Hoursᵢ), or number of days between day 1, Dᵢ₁, and day 2, Dᵢ₂, spent with respect to the skill, Skillₖ, as identified in the experiences of the CV. The number of days, Days (Dᵢ₂-Dᵢ₁), is weighted by an education weight, Education_weight, that may be predefined. As an example, the education weight may be predefined based on educational degrees: a Bachelor, a Master, a PhD or above, as 1.25, 1.5, 1.75, respectively.

In an example embodiment, the importance score may be determined by applying a trained model to the skills in connection to the normalized task and the normalized roles. The model may be trained using a dataset collected from a plurality of surveys assessing the importance of each skill to the relevant task in the context of the role. In a further example embodiment, the importance scores determined using the trained model may be stored in a database and retrieved when the appropriate skill, normalized task, and normalized role connection is determined.

At S390, structured skill data for the raw data is generated. The structured skill data includes a skill vector of the skills extracted from the raw data. In an embodiment, the structured skill data may include the updated skill vector indicating the aggregated value of the skills and the scores (e.g., proficiency, importance, and the like, and any combination thereof). The generated structured skill data may be stored, for example, in a memory and/or database (e.g., the database 120, FIG. 1) with respect to the raw data and thus, be retrieved based on skills by, for example, a vector retrieval approach. In a further embodiment, the structured skill data includes the skills as the unique ID.

According to the disclosed embodiments, the method of extracting skills as described in FIG. 3 provides a progressive semantic proximity approach to semantically determine normalized roles and tasks in multiple stages for the extraction of skills. The semantic approach allows identification of roles and tasks based on understanding the language of the unstructured text data that are not only a more accurate representation of the unstructured data, but more efficient in that normalized roles and tasks may be identified for clusters of similar roles and tasks, respectively. It should be noted that the determination of normalized roles and normalized tasks by semantic proximity clustering reduces the number of individual roles and tasks to be discovered and stored, thereby conserving computing memory and processing power. In a further embodiment, the semantic proximity approach enables discovery of skills that are otherwise difficult to identify based on other techniques that do not consider the content, for example, keyword-based approaches. In such a scenario, unstructured data without exact keywords or terminology may be identified as very different roles and tasks to result, perhaps, unrelated skills. It should be further noted that the semantic proximity approach to identify one or more roles through ranking of semantic similarity scores provides a wider range of related tasks and skills associated with the different roles that are otherwise difficult to obtain with identification of a single role.

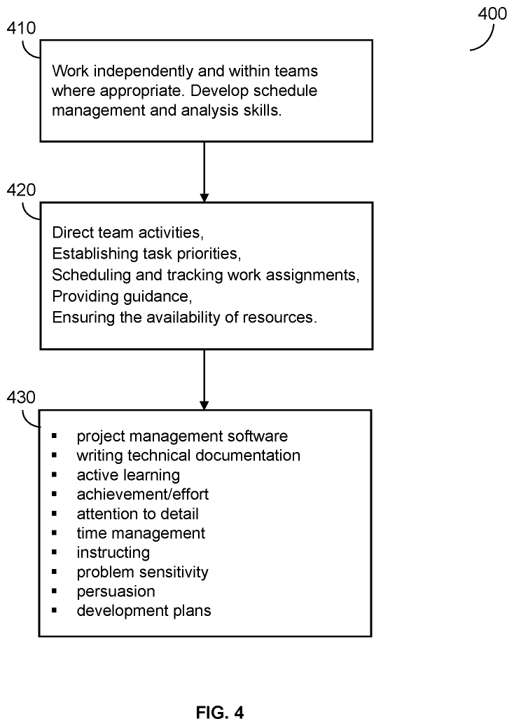

FIG. 4 is an example schematic diagram 400 illustrating extraction of skills from unstructured data in an example embodiment. The schematic diagram 400 shows the steps of identifying skills from semantic analysis of a single task data unit 410 as described in steps S350 through S370 in FIG. 3 above. Each text box (410 through 430) presents the content that is determined during the extraction process.

The mapping of skills is performed for an example role of a Technical Product Lead that may be associated with one or more normalized role that is identified from a job description raw data. It should be noted that the example is described with respect to a single task data unit for simplicity and illustrative purposes and does not limit the scope of the disclosed embodiments. It should be further noted that the skills generator 130, FIG. 1 simultaneously performs extraction of skills from multiple task data units, multiple raw data, and the like, that are received.

An example task data unit 410 is identified from the unstructured data of the job description. The task data unit 410 is a portion of the unstructured data that describes tasks of the role in the natural language. That is, the task data unit 410 is a free text that describes activities to be performed at the respective role of a Technical Product Lead. At least one algorithm, such as a semantic analysis, is applied to the task data unit 410 to determine at least one normalized task 420 for the task data unit 410.

Five normalized tasks are identified for the at least one normalized task 420 based on a ranking of semantic similarity scores from highest to lowest and/or above a predetermined threshold value. Such as score can be computed using, for example, a COSINE function. It should be noted that the at least one normalized task 420 is identified from a subset of normalized tasks that is generated for one or more normalized roles identified for the Technical Product Lead position of the raw data.

Next, a plurality of skills 430 are collected from the database (e.g., the database 120, FIG. 1) based on the at least one normalized task 420. The extracted plurality of skills 430 may be aggregated with skills determined from other task data units of the raw data. In addition, the aggregated skills may be stored as a skill vector of the structured skill data for future retrieval and matching with other raw data. As noted above, each skill may be configured with a unique ID for generation of the structured skill data.

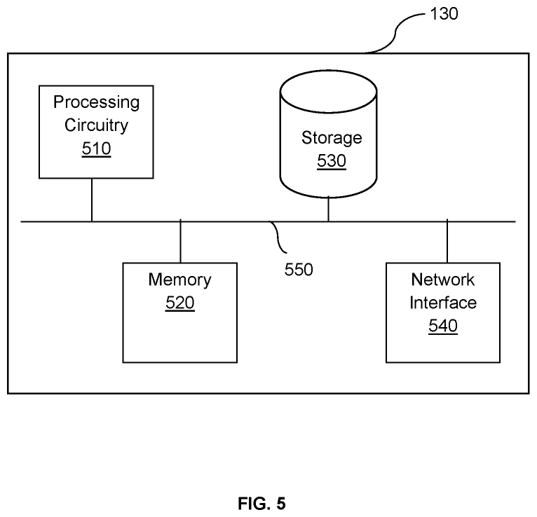

FIG. 5 is an example schematic diagram of a skills generator 130 according to an embodiment. The skills generator 130 includes a processing circuitry 510 coupled to a memory 520, a storage 530, and a network interface 540. In an embodiment, the components of the skills generator 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose central processing units (CPUs), microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the skills generator 130 to communicate with other elements over the network 110 for the purpose of, for example, receiving data, sending data, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), general purpose compute acceleration device such as graphics processing units (“GPU”), a memory, and input/output interfaces. The computer platform may also include an operating system and microinstruction code. The various processes and functions described herein may be either part of the microinstruction code or part of the application program, or any combination thereof, which may be executed by a CPU or a GPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for extracting skills from unstructured raw data, comprising:
determining at least one normalized role that matches a role of a raw data, wherein the match is determined based on a first semantic similarity score generated for each of normalized roles of a set of normalized roles;
generating a subset of normalized tasks that are associated with the at least one normalized role;
determining, based on a second semantic similarity score, at least one normalized task for a task data unit of the raw data, wherein the task data unit is a portion of the raw data that describes tasks of the role, wherein the at least one normalized task for the task data unit is a normalized task in the subset of normalized tasks;
aggregating skills that are associated with the at least one normalized task; and
generating structured skill data of the raw data using the aggregated skills.

2. The method of claim 1, wherein the second semantic similarity score defines a semantic proximity between the task data unit and the normalized task of the subset of normalized tasks.

3. The method of claim 1, wherein the matching at least one normalized role includes a predetermined number of normalized roles of the set of normalized roles with a top first semantic similarity scores.

4. The method of claim 1, further comprising:
providing the structured skill data of the raw data, wherein the structured skill data includes a skill vector of the aggregated skills.

5. The method of claim 1, further comprising:
segmenting the raw data into data units that describe the role in textual data; and
identifying the role of the raw data from the segmented data units.

6. The method of claim 1, further comprising:
determining a score for each skill of the aggregated skills with respect to the at least one normalized task and the at least one normalized role; and
generating a skill vector having weighted values with respect to the determined scores for each skill of the aggregated skills, wherein the structured skill data includes the generated skill vector.

7. The method of claim 6, further comprising:
building a database using the raw data and the respective structured skill data.

8. The method of claim 6, wherein the score is at least one of: a proficiency score and an importance score.

9. The method of claim 6, further comprising:
generating a query having at least one of the aggregated skills to retrieve potential matches of the raw data, wherein each of the potential matches include structured skill data that is stored in a database; and
determining a matching data for the raw data from the retrieved potential matches based on a comparison of the structured skill data of the raw data and the structured skill data of each of the potential matches.

10. A non-transitory computer readable medium having stored thereon instructions for causing a processing circuitry to execute a process, the process comprising:
determining at least one normalized role that matches a role of a raw data, wherein the match is determined based on a first semantic similarity score generated for each of normalized roles of a set of normalized roles;
generating a subset of normalized tasks that are associated with the at least one normalized role;
determining, based on a second semantic similarity score, at least one normalized task for a task data unit of the raw data, wherein the task data unit is a portion of the raw data that describes tasks of the role, wherein the at least one normalized task for the task data unit is a normalized task in the subset of normalized tasks;
aggregating skills that are associated with the at least one normalized task; and
generating structured skill data of the raw data using the aggregated skills.

11. A system for extracting skills from unstructured raw data, comprising:
one or more processors; and
a memory, the memory containing instructions that, when executed by the one or more processors, configure the system to:
determine at least one normalized role that matches a role of a raw data, wherein the match is determined based on a first semantic similarity score generated for each of normalized roles of a set of normalized roles;
generate a subset of normalized tasks that are associated with the at least one normalized role;
determine, based on a second semantic similarity score, at least one normalized task for a task data unit of the raw data, wherein the task data unit is a portion of the raw data that describes tasks of the role, wherein the at least one normalized task for the task data unit is a normalized task in the subset of normalized tasks;
aggregate skills that are associated with the at least one normalized task; and
generate structured skill data of the raw data using the aggregated skills.

12. The system of claim 11, wherein the second semantic similarity score defines a semantic proximity between the task data unit and the normalized task of the subset of normalized tasks.

13. The system of claim 11, wherein the matching at least one normalized role includes a predetermined number of normalized roles of the set of normalized roles with a top first semantic similarity scores.

14. The system of claim 11, wherein the system is further configured to:
provide the structured skill data of the raw data, wherein the structured skill data includes a skill vector of the aggregated skills.

15. The system of claim 11, wherein the system is further configured to:
segment the raw data into data units that describe the role in textual data; and
identify the role of the raw data from the segmented data units.

16. The system of claim 11, wherein the system is further configured to:
determine a score for each skill of the aggregated skills with respect to the at least one normalized task and the at least one normalized role; and
generate a skill vector having weighted values with respect to the determined scores for each skill of the aggregated skills, wherein the structured skill data includes the generated skill vector.

17. The system of claim 16, wherein the system is further configured to:
build a database using the raw data and the respective structured skill data.

18. The system of claim 16, wherein the score is at least one of: a proficiency score and an importance score.

19. The system of claim 16, wherein the system is further configured to:
generate a query having at least one of the aggregated skills to retrieve potential matches of the raw data, wherein each of the potential matches include structured skill data that is stored in a database; and
determine a matching data for the raw data from the retrieved potential matches based on a comparison of the structured skill data of the raw data and the structured skill data of each of the potential matches.
